(19) United States
(12) Patent Application Publication
(10) Pub. No.: US 2012/0162635 A1
(43) Pub. Date: Jun. 28, 2012

(54) FIBER OPTIC MEASURING DEVICE AND METHOD

(75) Inventors: Nicolas Brillouet, Castries (FR); Paul Coudray, Saint Jean de Cuculles (FR)

(73) Assignee: KLOE S.A., Montpellier (FR)

(21) Appl. No.: 13/392,897

(22) PCT Filed: Aug. 19, 2010
(86) PCT No.: PCT/FR2010/051741

§ 371 Date: Mar. 15, 2012

(30) Foreign Application Priority Data
Aug. 31, 2009 (FR) 0955939

(51) Int. Cl. G01L 1/24; G01K 11/32; G01D 5/353

(52) U.S. Cl. 356/32; 356/73.1; 374/161; 374/E11.015

(57) ABSTRACT

A measuring device including at least one optical fiber which contains a series of Bragg gratings distributed between first and second ends of the fiber. A light source is arranged to emit a luminous flux at multiple wavelengths incident on the first end of the fiber, and an instrument connected to the second end of the fiber measures the power of the light transmitted at each emitted wavelength, enabling implementation of the method. In the method the power of the light transmitted by the optical fiber in a spectrum including wavelengths is measured.

### FIELD OF THE INVENTION

The invention relates to a device for measuring environmental constraints of an industrial installation or of an engineering structure, of photo-induced Bragg gratings in the core of an optical fiber. These constraints may be related to a variation of temperature, to a deformation of the structure, or to a pressure related to a passage. Any constraint induces a modification of the period of one or more Bragg gratings which is expressed by a modification of the signal reflected by the Bragg grating(s).

### BACKGROUND

Many methods and devices for measuring a light flux reflected by Bragg gratings in an optical fiber are already known. Thus, document FR 2 674 639 proposes placement on a same fiber of a large number of sensors recognized from each other either by the wavelength λₛ on which the act either by their distance relatively to the central measuring system.

Nevertheless, the number of sensors allowed by the present state of the art remains limited since measurements on the reflective flux pose synchronization problems.

### SUMMARY OF THE INVENTION

In order to find a remedy to the problems posed by the prior state of the art, the object of the invention is a measuring device comprising an optical fiber which contains a succession of Bragg gratings distributed between a first end and a second end. Remarkably, the method comprises a light source arranged so as to emit a light flux at several wavelengths in the first end of the fiber, and an instrument connected to the second end of the fiber for measuring light power transmitted at each emitted wavelength.

Advantageously, the measuring device comprises at least one second optical fiber which contains a succession of Bragg gratings distributed between a first end and a second end connected to the measuring instrument and a switch positioned between the light source and the first end of each optical fiber so as to emit the light flux in each of the optical fibers.

Preferably, several wavelengths in a spectral range of 200 nm, are each assigned to a different Bragg grating so that an interval between two wavelengths comprised between 1.5 and 2 nm, allows implementation of about 100 Bragg gratings per filter. A larger interval simply decreases the number of gratings per fiber.

Particularly, at least one optical fiber is firmly attached to a structure in order to measure mechanical stresses to which the structure is subjected. More particularly, the density of Bragg gratings along the optical fiber is proportional to a sought accuracy on a stress localization.

Also particularly, at least one optical fiber comprises a sheath in a material belonging to the family of materials with good strength at low temperature comprising polyimides so as to measure temperatures in the cryogenic domain. More particularly, at least one optical fiber comprises a sheath of a material belonging to the family of materials with a good strength at high temperature comprising polyimides and metals so as to measure temperatures in the domain of high temperatures.

Advantageously, the Bragg gratings are photo induced in at least one optical fiber.

The object of the invention is also a method for measuring by means of an optical fiber containing Bragg gratings at different diffraction wavelengths. The method is remarkable in that it consists of measuring light power transmitted by the optical fiber in a spectrum comprising the wavelengths.

### BRIEF DESCRIPTION OF DRAWING FIGURES

The invention will be better understood upon reading the following description and upon examining the figures which accompany it. These figures are given as an illustration and by no means as a limitation of the invention.

FIG. 1 shows a measuring device by reflection in an optical fiber;

FIG. 2 shows a measuring device by transmission in an optical fiber.

### DETAILED DESCRIPTION

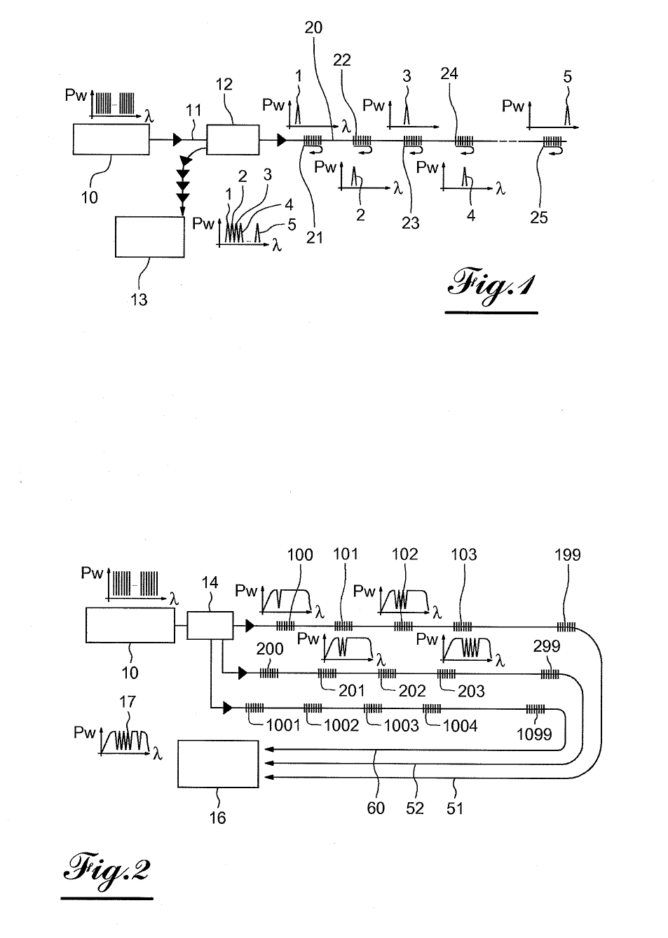

With reference to FIG. 1, an optical signal is emitted by a laser source 10 which is tunable or with a wide spectral band. This optical signal is injected into an optical fiber 20, in which one or several Bragg gratings 21, 22, 23, 24, 25 have been photo-induced. The Bragg gratings may be photo induced in the optical fibers in different ways, such as, as a non-limiting example, the one described in the patent FR 2 830 626. It is recalled that a Bragg grating is a fine periodic structure consisting of a succession of areas with strong and weak refractive indexes. Each Bragg grating 21, 22, 23, 24, 25 has its own period, a so-called Bragg period. To each period corresponds a diffraction wavelength and a diffraction band width. At the diffraction wavelength, the optical signal crossing the Bragg grating is reflected, while all the other wavelengths are transmitted through this grating. A modification of the environmental conditions of the optical fiber 20, which for example results from a variation of temperature, from a variation of pressure, from a deformation of the filter, for example, by shearing or other ways, induces a modification of the diffraction wavelength of the Bragg grating. This modification induces a displacement of the diffraction peak in the spectral band. Conventionally, as this is the case illustrated in FIG. 1, the measuring systems use the signal reflected by the Bragg grating.

The adjustable laser source 10 is dimensioned so as to sweep through a light spectrum, the wavelengths of which vary for example from 1,450 nm to 1,650 nm. A laser ray 11 emitted by the laser source 10 is then sent into the fiber 20 while passing through a coupler 12. When the wavelength λ₁ of the light transmitted in the fiber 20 corresponds to the reflection wavelength of the Bragg grating 21, a spectral band 1 of wavelength λ₁ and of reflected power PW (λ₁), again passes in the coupler 12 where it is deviated towards a measuring device 13. In order that the reflected light is not sent back towards the laser source 10 but towards the measuring device 13, the coupler 12 is, for example, a circulator. It is recalled that a circulator is a device with a finite number of input-outputs such as a signal entering through an entrance, exits through the following exit. When the wavelengths λ₂, λ₃, λ₄, and λ₅, respectively, of the light transmitted in the fiber 20 correspond to the reflection wavelength of the Bragg grating 22, 23, 24, and 25, respectively, a spectral band 2, 3, 4, and 5, respectively, of wavelengths λ₂, λ₃, and λ₅, respectively, and of reflected power PW (λ₂), PW (λ₃), PW (λ₄), PW(λ₅), again passes in the coupler 12 where it is deviated towards the power measuring device 13.

In reflection, the number of Bragg gratings is necessarily limited since a large number of Bragg gratings, each spaced apart by a small wavelength difference, poses a considerable synchronization problem between the pieces of equipment for emitting the optical signal represented by the tunable laser 10 and the reception equipment represented by the measuring equipment 13. Indeed, in reflection, the optical signal crosses twice all the Bragg gratings. Any synchronization error may induce an interpretation error of the measured spectrum, and therefore measurement errors. In reflection, post processing is indispensable.

It is specified that in order to operate in reflection, the requirement of using a circulator which is a component for which the operating wavelength range, in other words, the passband, is relatively limited, typically of the order of 50 nm to a maximum of 100 nm, limits the utilizable wavelength range for this type of measurement and, a fortiori, the benefit of working with tunable sources covering a range of about 200 nm. Operating in transmission, which is presently explained, gives the possibility of using the full potential of the 200 nm of the tunable laser source since in this case, no circulator is required.

The device according to the invention, a possible embodiment of which is illustrated by FIG. 2, uses the signal transmitted by an optical fiber 51, 52, 60 in which the number of Bragg gratings 100, 101, 102, 103 . . . , 199 may easily reach about one hundred Bragg gratings per optical fiber. In a device according to the invention, each Bragg grating has its own period.

Each period corresponds to a wavelength for which light is diffracted by the Bragg grating when the fiber section which accommodates the Bragg grating, is in a reference state. When the fiber section expands, under the effect of (i) a tensile stress, (ii) an increase in temperature, or (iii) any other physical phenomenon causing expansion of the section, the value of the wavelength increases relative to that of the initial state. Conversely, when the fiber section retracts, under the effect of (i) a compressive stress, a (ii) reduction in temperature, or (iii) any other physical phenomenon causing shrinkage of the section, the value of the wavelength decreases relative to that of the initial state.

The laser source 10 then generates a discrete spectrum of pulses in an interval surrounding the wavelength associated with the reference state. A deviation of 10 picometers in wavelength between two pulses, for example, allows an accuracy of 1° K to be obtained on a measurement of temperature. Correlatively, a deviation of one picometer in wavelength between two pulses allows an accuracy of 0.1° K to be obtained on the measurement of temperature. In transmission, it is then sufficient to count the number of pulses which separates the non transmitted pulse from the pulse for which the wavelength is associated with the reference state, in order to infer the change in state, notably the temperature change, relative to the reference state, notably relative to the reference temperature.

The wavelength spacing between each Bragg grating is small, of the order of a few nanometers. An instrument 16 for examining this type of optical fiber, is positioned at an opposite end of the fiber relative to the one which receives the laser ray from the source 10.

By examining all the induced Bragg gratings in the optical fiber in transmission rather than in reflection, it is possible to relax the synchronization constraint and consequently to have a more accurate measurement, in real time, because of not requiring any post-processing for interpreting the spectra measured by the instrument 16. The device of FIG. 2 requires deployment of a longer fiber for conveying the signal as far as the instrument 16, most often installed on the same chassis as the laser source 10. The Bragg gratings 100, 101, 102, 103 . . . , 199 may be distributed over the first half of the optical fiber 51, corresponding to the outbound path, so that the return path of the fiber 51 is without any Bragg grating. According to an alternative embodiment, not shown, the Bragg gratings may be uniformly distributed on the outbound path and on the return path of the fiber 51.

When a spectrum of power PW with a spectral range of 200 nm, crosses the Bragg grating 100, a portion of the reflected power PW generates a first trough in the transmitted power which corresponds to the diffraction wavelength of the Bragg grating 100. Next, when the remaining power spectrum PW successively crosses the Bragg gratings 101, 102, 103 . . . , 199, the additional reflected power portion PW generates another trough in the transmitted power which corresponds to the diffraction wavelength of each Bragg grating 101, 102, 103, . . . , 199. A distinct wavelength may be assigned to each of the Bragg gratings by separating two successive wavelengths between 1.5 and 2 nm.

Finally, the remaining power spectrum PW 17 which arrives at the measuring instrument 16 has a number of troughs equal to the number of Bragg gratings, each corresponding to a specific Bragg grating.

The device of FIG. 2 gives the possibility of conducting measurements of temperatures and of temperature variations along the optical fiber 51 at each point where a Bragg grating has been induced. Measurement of variations of temperatures in the cryogenic domain may notably be conducted at temperatures of −100° C. with an optical fiber with a polyimide cladding or at −180° C. with optical fibers of the “chryofiber™” type produced by IXFiber. Lowering of the temperature induces a contraction of the fiber, and, therefore a contraction of the period of each Bragg grating subject to the lowering of temperature. At a low temperature, a displacement of the troughs in the spectrum 17 is observed towards the left relative to the observable spectrum at room temperature.

By synchronizing the sweeping of the spectrum by the laser source 10 on a common clock with the measuring instrument 16, the wavelength corresponding to a trough may be determined according to the length of a fiber and to the speed of light in the fiber.

In an enhanced version, the device comprises a Bragg grating, for example the grating 100, located in a portion of the fiber, the temperature of which is accurately known. The wavelength λᵣ then accurately known of the Bragg grating is used as a reference for controlling the validity of the measurement and thereby determining the equivalent temperatures at other wavelengths with accuracy. By taking the instant when the trough of wavelength λᵣ is received as an origin of times, the duration which separates the receiving of a following trough in the instrument 16 is directly dependent on the duration which separates a next wavelength emission from the reference wavelength λᵣ.

The device of FIG. 2 also allows measurements of temperatures and of variations of temperatures at temperatures above 350° C., with an optical fiber with polyimide cladding, or at temperatures above 500° C. with special fibers with metal cladding. An increase in the temperature induces expansion of the optical fiber, therefore an increase in the period of each Bragg grating in a region of the fiber subjected to a rise in temperatures.

A transmission measuring method which uses the device illustrated in FIG. 2 also allows measurement of structure deformations by extension of the optical fiber, shearing, torsion, pressure or even failure of the optical fiber when the optical fiber is firmly attached to the structure. Each of these mechanical stresses inducing a modification in the length and consequently of the period of one or several Bragg gratings, and the position of the stressed Bragg grating give the possibility of localizing the mechanical stress to which the structure was subjected. The higher the density of Bragg gratings along the fiber, the better is the accuracy of the localization of the stress.

The transmission measurement method gives the possibility of monitoring several optical fibers installed along a structure. The use of an optical switch 14 gives the possibility of successively examining each of the optical fibers 51, 52, . . . , 60, by connecting an end to a system comprising the laser source 10 and the other end to the measuring instrument 16. Optical switches 14 with two, four, and eight routes may be used. Thus it is possible to connect to a second route the optical fiber 52 over which are distributed up to 100 Bragg gratings 200, 201, 202, 203, . . . , 299. Also, on the latter route, a fiber 60 including a large number of Bragg gratings 1001, 1002, 1003,1004, . . . , 1099 may be connected.

1. A measuring device comprising:
first optical fiber having first and second ends and containing a succession of Bragg gratings distributed between the first end and the second end;
a light source positioned to emit into the first end of the first fiber a light flux at several wavelengths in a spectral range of 200 nm, each wavelength being assigned to a different, respective, Bragg grating; and
an instrument connected to the second end of the first fiber for measuring light power transmitted through the optical fiber at each wavelength emitted by the light source.

2. The measuring device according to claim 1, further comprising:
a second optical fiber having a first end and a second end and containing a succession of Bragg gratings distributed between the first end and the second end of the second optical fiber, with the second end of the second optical fiber connected to the measuring instrument; and
a switch positioned between the light source and the first end of each of the first and second optical fibers for selectively emitting the light flux into the first and second optical fibers.

3. The measuring device according to claim 1, wherein two wavelengths between 1.5 and 2 nm are sufficiently spaced for controlling 100 Bragg gratings in the first optical fiber.

4. The measuring device according to claim 1, wherein the first optical fiber is firmly attached to a structure in order to measure mechanical stresses to which the structure is subjected.

5. The measuring device according to claim 4, wherein density of Bragg gratings along the first optical fiber is proportional to desired accuracy of localization of a stress applied to the structure.

6. The measuring device according to claim 1, wherein the first optical fiber comprises a sheath of a polyimide for measuring cryogenic temperatures.

7. The measuring device according to claim 1, fiber comprises a sheath selected from polyimides and metals for measuring high temperatures.

8. The measuring device according to claim 1, wherein the Bragg gratings are photo-induced in the first optical fiber.

9. A measurement method using an optical fiber containing Bragg gratings having different diffraction wavelengths, each wavelength corresponding to a different, respective, Bragg grating in a spectral range of 200 nm, the method comprising measuring light power transmitted through the optical fiber in a spectrum of the wavelengths.
